(19) United States
(12) Patent Application Publication
(10) Pub. No.: US 2025/0038372 A1
(43) Pub. Date: Jan. 30, 2025

(54) BATTERY AND ELECTRONIC DEVICE

(71) Applicant: Zhuhai CosMX Battery Co., Ltd., Zhuhai (CN)

(72) Inventors: Shuai DU, Zhuhai (CN); Yongwang WANG, Zhuhai (CN); Yuxiang ZENG, Zhuhai (CN)

(21) Appl. No.: 18/918,254

(22) Filed: Oct. 17, 2024

Related U.S. Application Data
(63) Continuation of application No. PCT/CN2023/113338, filed on Aug. 16, 2023.

(30) Foreign Application Priority Data
Nov. 18, 2022 (CN) 202223078072.7

(51) Int. Cl. H01M 50/536; H01M 50/103; H01M 50/176; H01M 50/533; H01M 50/55

(52) U.S. Cl. CPC H01M 50/536; H01M 50/103; H01M 50/176; H01M 50/533; H01M 50/55

(57) ABSTRACT

The present application provides a battery and an electronic device. The battery provided by the present application includes a battery cell, an outer shell assembly and a first connecting assembly. The outer shell assembly includes a pole and an outer shell, and the outer shell has an accommodate chamber, and the battery cell is disposed in the accommodate chamber. The first connecting assembly includes a first connector and a second connector, the first connector is connected to a tab of the battery cell, the second connector is connected to the pole, the first connector has a first engaging portion, the second connector has a second engaging portion, the first engaging portion and the second engaging portion are engaged with each other. The present application provides a battery and an electronic device, improving the production qualification rate of battery.

### CROSS-REFERENCE TO RELATED APPLICATIONS

This present application is a continuation of International Application No. PCT/CN2023/113338, filed on Aug. 16, 2023, which claims priority to Chinese Patent Application No. 202223078072.7, filed on Nov. 18, 2022. The disclosures of the aforementioned applications are hereby incorporated by reference in their entireties

### TECHNICAL FIELD

The present application relates to the field of new energy, and in particular, to a battery and an electronic device.

### BACKGROUND

Battery is a device that converts chemical energy into electrical energy, which has a wide range of applications in daily life. With the development of the battery industry, there are increasingly high requirements of enterprises for the production efficiency and qualification rate of battery.

The existing battery generally includes a battery cell, an outer shell, a first adapter sheet and a second adapter sheet, where the first adapter sheet is used to connect with electrodes of a battery cell, and the second adapter sheet is connected between the first adapter sheet and the outer shell, so as to lead the electrodes to the outside of the outer shell for easy use.

However, the inventor found that in the prior art, when the first adapter sheet is connected to the second adapter sheet, it is easy to occur relative slide of the first adapter sheet and the second adapter sheet, resulting in a decrease in the accuracy of subsequent welding, an increase in the defective rate of welding, and ultimately a decrease in the qualification rate of battery.

### SUMMARY

To solve at least one of the problems mentioned in the background, the present application provides a battery and an electronic device, improving the production qualification rate of battery.

To achieve the above purpose, the present application provides the following technical solutions.

In a first aspect, the present application provides a battery, the battery includes a battery cell, an outer shell assembly and a first connecting assembly. The outer shell assembly includes a pole and an outer shell, the outer shell has an accommodate chamber, and the battery cell is disposed in the accommodate chamber;
the first connecting assembly includes a first connector and a second connector, the first connector is connected to a tab of the battery cell, the second connector is connected to the pole, the first connector has a first engaging portion, the second connector has a second engaging portion, the first engaging portion and the second engaging portion are engaged with each other.

As an implementation, the first engaging portion is a convex portion and the second engaging portion is a concave portion, or the first engaging portion is a concave portion and the second engaging portion is a convex portion, and the convex portion is embedded in the concave portion.

As an implementation, the first connector includes a first connecting sheet connected to the second connecting sheet, and a fourth connecting sheet connected to a side of the tab facing away from the battery cell.

As an implementation, the first connector further includes a second connecting assembly connected to the first connecting sheet and the fourth connecting sheet respectively; the second connecting assembly includes a second connecting sheet and a third connecting sheet; the second connecting sheet is located between the second connector and the battery cell; along a first direction, the third connecting sheet is located between the tab and the second connector; the first connecting sheet, the second connecting sheet, the third connecting sheet and the fourth connecting sheet are sequentially connected.

As an implementation, the first connecting sheet has a convex portion, a side wall of the second connector has a concave portion, and the convex portion protrudes to a side of the second connector.

As an implementation, there are a plurality of convex portions, the plurality of convex portions are disposed at intervals on the first connecting sheet along the first direction.

As an implementation, a cross section of the convex portion is circular-shaped or polygon-shaped.

As an implementation, the concave portion is a through hole or a groove formed on the second connector.

As an implementation, the number of first connecting assemblies is two, and two first connecting assemblies are connected to a positive-electrode tab and a negative-electrode tab of the battery cell respectively; the second connector in the first connecting assembly connected to the positive-electrode tab is connected to the pole, and the second connector in the first connecting assembly connected to the negative-electrode tab is connected to the outer shell.

As an implementation, the second connector and the second connecting sheet are welded together and a welded surface between the second connector and the second connecting sheet is parallel to a bottom of the outer shell.

As an implementation, the convex portion is a convex column, the concave portion is a concave hole, and a diameter of the convex column minus a diameter of the concave hole is greater than 0.05 mm.

As an implementation, a height of the convex column and a depth of the concave hole are 0.5 mm-30 mm.

In a second aspect, the present application also provides an electronic device, the electronic device includes the battery according to any one of the second aspect.

The battery provided by the present application includes a battery cell, an outer shell assembly and a first connecting assembly. The outer shell assembly includes a pole and an outer shell, and the outer shell has an accommodate chamber, and the battery cell is disposed in the accommodate chamber; the first connecting assembly includes a first connector and a second connector, the first connector is connected to a tab of the battery cell, and the second connector is connected to the pole. The first connector has a first engaging portion, the second connector has a second engaging portion, the first engaging portion and the second engaging portion are engaged with each other. In the battery provided by the present application, the first engaging portion is disposed on the first connector, the second engaging portion matched with the first engaging portion is disposed on the second connector. When the first connector and the second connector are welded, the first engaging portion the first connector and the second engaging portion on the second connector can be engaged. This can prevent the relative slip of the first connector and the second connector in the welding process, so as to achieve the accurate and rapid positioning between the first connector and the second connector, and improve the qualification rate and efficiency of producing the battery.

### BRIEF DESCRIPTION OF DRAWINGS

To describe the technical solutions in embodiments of the present application or in the prior art more clearly, the following briefly introduces the accompanying drawings needed for describing the embodiments or the prior art. Apparently, the accompanying drawings in the following description illustrate merely some embodiments of the present application, and persons of ordinary skill in the art may still derive other drawings from these accompanying drawings without creative effort.

FIG. 1 is an overall structural schematic diagram of a battery provided by an embodiment of the present application.

FIG. 2 is a schematic diagram of the assembling of a first connector and a second connector in a battery provided by an embodiment of the present application.

FIG. 3 is another schematic diagram of the assembling of a first connector and a second connector in a battery provided by an embodiment of the present application.

FIG. 4 is a side view of FIG. 3.

FIG. 5 is a section view taken along A-A in FIG. 4.

### DESCRIPTION OF REFERENCE NUMBERS

100—battery;
110—battery cell;
111—tab;
120—outer shell assembly;
121—pole;
122—outer shell;
130—first connecting assembly;
131—first connector;
1311—first engaging portion;
1312—first connecting sheet;
1313—second connecting sheet;
1314—third connecting sheet;
1315—fourth connecting sheet;
132—second connector;
1321—second engaging portion;
X—first direction.

### DESCRIPTION OF EMBODIMENTS

The following clearly and comprehensively describes the technical solutions in embodiments of the present application with reference to the accompanying drawings in embodiments of the present application. Apparently, the described embodiments are merely a part rather than all embodiments of the present application. All other embodiments obtained by persons of ordinary skill in the art based on embodiments of the present application without creative effort shall fall within the protection scope of the present application.

In the application, the orientations or position relationships indicated by the terms “up”, “down”, “left”, “right”, “front”, “back”, “top”, “bottom”, “inside”, “outside”, “vertical”, “horizontal”, “longitudinal”, “transverse”, etc. are based on the orientations or position relationships shown in the accompanying drawings. These terms are mainly intended to better describe the present application and embodiments thereof, and not to limit that the indicated devices, elements, or components must have a specific orientation or be constructed and operated in a specific orientation.

In addition, some of the above terms may be used to indicate other meanings in addition to indicating orientation or position relationships, such as the term “up” may also be used to indicate an attachment or connection relationship in some cases. For persons of ordinary skill in the art, the specific meaning of these terms in the present application can be understood according to the specific situations.

In addition, the terms “mounted”, “disposed”, “provided”, “connected to”, “connected with”, etc. shall be understood in a broad sense. For example, the connection may be a fixed connection, a detachable connection, or an integral construction; may be a mechanical connection, or an electrical connection; the connection may be direct connection, or indirect connection by an intermediate medium, or may be communication between two devices, elements or components. For persons of ordinary skill in the art, the specific meaning of the above terms in the present application can be understood according to the specific situations.

In addition, the terms such as “first” and “second” are mainly used to distinguish different devices, elements or components (specific kinds and constructions may be the same or different) and are not used to indicate or imply the relative importance and quantity of the indicated devices, elements or components. Unless otherwise expressly specified, “a plurality of” means two or more.

Battery is a device that converts chemical energy into electrical energy, which has a wide range of applications in daily life. With the development of the battery industry, there are increasingly high requirements of enterprises for the production efficiency and qualification rate of battery. The existing battery generally includes a battery cell, an outer shell, a first adapter sheet and a second adapter sheet, where the first adapter sheet is used to connect with electrodes of a battery cell, and the second adapter sheet is connected between the first adapter sheet and the outer shell, so as to lead the electrodes to the outside of the outer shell for easy use. However, when the first adapter sheet is connected to the second adapter sheet, it is easy to occur relative slide between the first adapter sheet and the second adapter sheet, resulting in a decrease in the accuracy of subsequent welding, an increase in the defective rate of welding, and ultimately a decrease in the qualification rate of battery.

In view of this, the present application provides a battery, the battery includes a battery cell, an outer shell assembly and a first connecting assembly. The outer shell assembly includes a pole and an outer shell, the outer shell has an accommodate chamber, and the battery cell is disposed in the accommodate chamber; the first connecting assembly includes a first connector and a second connector, the first connector is connected to a tab of the battery cell, the second connector is connected to the pole, the first connector has a first engaging portion, the second connector has a second engaging portion, the first engaging portion and the second engaging portion are engaged with each other. In the battery provided by the present application, the first engaging portion is disposed on the first connector, the second engaging portion matched with the first engaging portion is disposed on the second connector. When the first connector and the second connector are welded, the first engaging portion on the first connector and the second engaging portion on the second connector can be engaged.

This can prevent the relative slip between the first connector and the second connector in the welding process, so as to achieve the accurate and rapid positioning between the first connector and the second connector, and improve the qualification rate and efficiency of producing the battery.

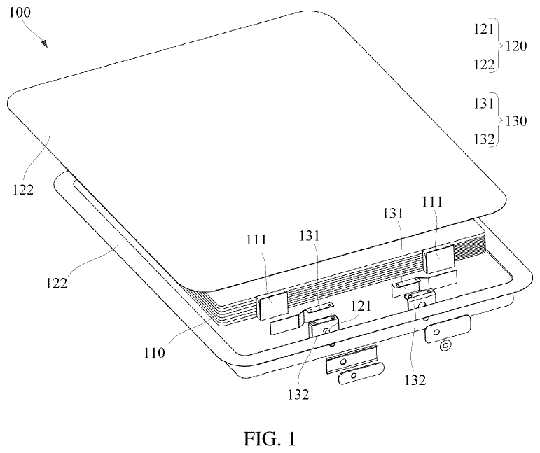

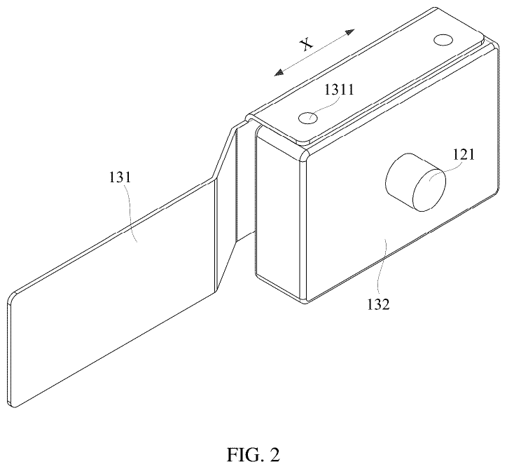

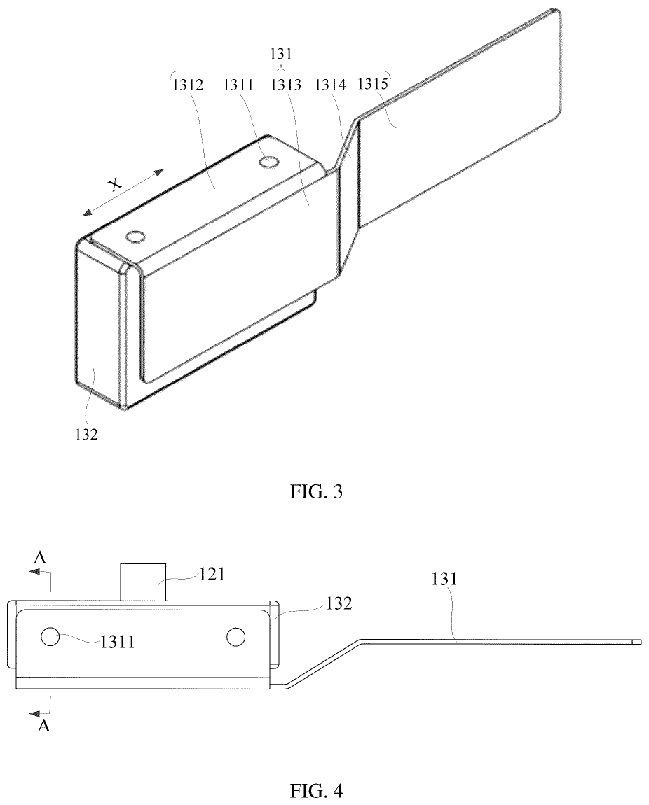

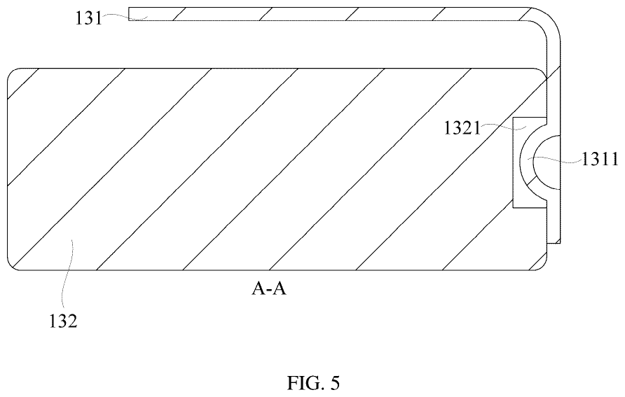

FIG. 1 is an overall structural schematic diagram of a battery provided by an embodiment of the present application; FIG. 2 is an schematic diagram of the assembling of a first connector and a second connector in a battery provided by an embodiment of the present application; FIG. 3 is another schematic diagram of the assembling of a first connector and a second connector in a battery provided by an embodiment of the present application; FIG. 4 is a side view of FIG. 3; FIG. 5 is a section view taken along A-A in FIG. 4. Referring to FIGS. 1 to 5, an embodiment of the present application provides a battery 100, the battery 100 includes a battery cell 110, an outer shell assembly 120 and a first connecting assembly 130. The outer shell assembly 120 includes a pole 121 and an outer shell 122. The outer shell 122 has an accommodate chamber, and the battery cell 110 is disposed in the accommodate chamber; the first connecting assembly 130 includes a first connector 131 and a second connector 132, the first connector 131 is connected to a tab 111 of the battery cell 110, the second connector 132 is connected to the pole 121; the first connector 131 has a first engaging portion 1311, the second connector 132 has a second engaging portion 1321, the first engaging portion 1311 and the second engaging portion 1321 are engaged with each other.

Where the battery cell 110 includes a negative electrode made of a negative electrode material, a positive electrode made of a positive electrode material and a separator separating the positive and negative electrodes. The setting mode of the battery cell 110 may be coil-type, stack-type, etc., which is not specified in this embodiment.

It should be noted that the outer shell 122 plays a role of protecting the battery cell 110, and the outer shell 122 can be formed by two parts to facilitate installation. Stainless steel may be selected as the material of the outer shell 122, and is sturdy and corrosion-resistant. Of course, other materials may also be selected for the outer shell 122, which are not specifically limited in this embodiment.

Where, the first connector 131 can be welded with the tab 111 of the battery cell 110, the second connector 132 is welded with the first connector 131, and then the second connector 132 is connected to the outer shell assembly, therefore, the electrodes of the battery cell 110 may be electrically leaded out.

In particular, the number of the first connecting assembly 130 may be two, and two first connection assemblies 130 are connected to a positive-electrode tab 111 of the battery cell 110 and a negative-electrode tab 111 of the battery cell 110 respectively; the second connector 132 in the first connecting assembly 130 connected to the positive-electrode tab 111 is connected to the pole 121, and the second connector 132 in the first connecting assembly 130 connected to the negative-electrode tab 111 is connected to the outer shell 122. For case of understanding, two first connecting assemblies 130 may be defined as a first connecting assembly 130 and a second first connecting assembly 130. It can be understood that each of the first connecting assembly 130 and the second first connecting assembly 130 includes a pair of the first connector 131 and the second connector 132. The first connector 131 of the first connecting assembly 130 may be connected to the negative-electrode tab 111 of the battery cell 110, and accordingly, an end of the second connector 132 of the first connecting assembly 130 is connected to the outer shell 122. Therefore, the negative electrode of the battery cell 110 is electrically leaded to the outer shell 122, and the entire outer shell 122 is used as the negative electrode of the battery 100. The first connector 131 of the second first connecting assembly 130 may be connected to the positive-electrode tab 111 of the battery cell 110, and accordingly, an end of the second connector 132 of the second first connecting assembly 130 is connected to the pole 121. Therefore, the positive electrode of cell 110 is electrically leaded to the pole 121, where the pole 121 is electrically insulated from the outer shell 122. This ensures that the positive and negative electrodes of the battery 100 do not interfere with each other and work normally. The pole 121 is generally made of a material with good electrical conductivity, such as aluminum, copper, etc., a pole hole can be provided in the outer shell 122. The pole 121 can be directly integratedly formed with the second connector 132. When assembling, the pole 121 extends out of the outer shell 122 from the outer shell 122 through the pole hole, so as to achieve that the positive electrode of the battery cell 110 can be electrically leaded out of the outer shell 122.

In an implementation, the second connector 132 connected to the pole 121 can be processed into a connection block, and the second connector 132 connected to the outer shell 122 can be processed into a connecting sheet, the shape of the connecting sheet is similar to C-type, it is convenient for subsequent assembly.

In the above embodiment, the first connector 131 and the second connector 132 may be made of a material with good electrical conductivity and ductility, such as copper or aluminum. Of course, the first connector 131 and the second connector 132 may also be made of other materials, which are not specifically restricted in this embodiment.

In the battery 100 provided by embodiments of the present application, a first engaging portion 1311 is disposed on the first connector 131 and a second engaging portion 1321 matched with the first engaging portion 1311 is disposed on the second connector 132. When the first connector 131 and the second connector 132 are welded, the first engaging portion 1311 on the first connector 131 and the second engaging portion 1321 on the second connector 132 can be engaged. This can prevent the relative slip of the first connector 131 and second connector 132 in the welding process, so as to achieve the accurate and rapid positioning between the first connector 131 and the second connector 132, and improve the qualification rate and efficiency of producing the battery 100.

In the above embodiment, the first engaging portion 1311 may be a convex portion and the second engaging portion 1321 may be a concave portion, or the first engaging portion 1311 may be a concave portion and the second engaging portion 1321 may be a convex portion, and the convex portion is embedded in the concave portion.

In the above embodiment, the first connector piece 131 may include a first connecting sheet 1312 connected to the second connector 132 and a fourth connecting sheet 1315 connected to a side of the tab 111 facing away from the battery cell 110.

As shown in FIG. 3, in the above embodiment, the first connector 131 may also include a second connecting assembly connected to the first connecting sheet 1312 and the fourth connecting sheet 1315 respectively; the second connecting assembly includes a second connecting sheet 1313 and a third connecting sheet 1314; the second connecting sheet 1313 is located between the second connector 132 and the battery cell 110; along the first direction X (the X direction shown in FIGS. 2 and 3), the third connecting sheet 1314 is located between the tab 111 and the second connector 132; the first connecting sheet 1312, the second connecting sheet 1313, the third connecting sheet 1314, and the fourth connecting sheet 1315 are sequentially connected.

In the above embodiment, the first connecting sheet 1312 may have a convex portion (the first engaging portion 1311), and a side wall of the second connector 132 may have a concave portion (the second engaging portion 1321), and the convex portion protrudes to a side of the second connector 132.

In the above embodiments, there are a plurality of convex portions, the plurality of convex portions are disposed at intervals on the first connecting sheet 1312 along the first direction X. When the first connector 131 and the second connector 132 abuts against each other, the plurality of convex portions on the first connector 131 are simultaneously embedded in corresponding convex portions on the second connector 132. This is not only prevents the first connector 131 from sliding relative to the second connector 132, but also further prevents the first connector 131 from rotating relative to the second connector 132, and improves the reliability of welding.

Where, the shape of the convex portion can be implemented in various ways, for example, the cross section of the convex portion can be processed into circular shape or polygon shape, and correspondingly, the cross section of the concave portion and the shape of the convex portion can be matched with each other. The cross section of the convex portion is round-shaped, this is relatively simple to process. When the cross section of the convex portion is polygon, this can prevent the first connector 131 from sliding relative to the second connector 132, and prevent the first connector 131 from rotating relative to the second connector 132.

The overall shape of the convex portion can also be processed into hemispherical shape, correspondingly, the concave portion is also processed into hemispherical shape. This processing method is relatively simple, only stamping forming technology may be needed to perform simple stamping on surfaces of the first connector 131 and the second connector 132, so as to reduce processes. In addition, because the shape of the convex portion and the concave portion is hemispherical shape, when the first connector 131 and the second connector 132 abuts against each other for positioning, the convex portion on the first connector 131 is easily “slipped” into the concave portion as long as the convex portion is partially in contact with the concave portion on the second connector 132. Therefore, the positioning process of the first connector 131 and the second connector 132 can be completed. In particular, the concave portion may be a through hole or a groove formed on the second connector 132.

In the above embodiment, the second connector 132 and the second connecting sheet 1313 may be welded together and the welded surface between the second connector 132 and the second connecting sheet 1313 may be parallel to a bottom of the outer shell 122.

As shown in FIG. 5, in the above embodiments, the convex portion may be a convex column, the concave portion a concave hole, and a diameter of the convex column minus a diameter of the concave hole is greater than 0.05 mm.

In an implementation, the height of the convex column and the depth of the concave hole can be 0.5 mm-30 mm.

In the second aspect, the present application further provides an electronic device, the electronic device includes the battery 100 according to any one of the second aspect.

The battery 100 provided by embodiments of the present application includes a battery cell 110, an outer shell assembly 120 and a first connecting assembly 130. The outer shell assembly 120 includes a pole 121 and an outer shell 122. The outer shell 122 has an accommodate chamber, and the battery cell 110 is disposed in the accommodate chamber; the first connecting assembly 130 includes a first connector 131 and a second connector 132, the first connector 131 is connected to a tab 111 of the battery cell 110, the second connector 132 is connected to a pole 121, the first connector 131 has a first engaging portion 1311, the second connector 132 has a second engaging portion 1321, the first engaging portion 1311 and the second engaging portion 1321 are engaged with each other. In the battery 100 provided by embodiments of the present application, the first engaging portion 1311 is disposed on the first connector 131 and a second engaging portion 1321 matched with the first engaging portion 1311 is disposed on the second connector 132. When the first connector 131 and the second connector 132 are welded, the first engaging portion 1311 on the first connector 131 and the second engaging portion 1321 on the second connector 132 can be engaged. This can prevent the first connector 131 and the second connector 132 from sliding, thereby achieving the accurate and rapid positioning between the first connector 131 and the second connector 132, and improving the qualification rate and efficiency of producing the battery 100.

In addition, the present application further includes an electronic device, the electronic device includes the battery 100 in any one of the above embodiments, the battery 100 includes a battery cell 110, an outer shell assembly 120, and a first connecting assembly 130. The outer shell assembly 120 includes a pole 121 and an outer shell 122. The outer shell 122 has an accommodate chamber, and the battery cell 110 is disposed in the accommodate chamber; the first connecting assembly 130 includes a first connector 131 and a second connector 132, the first connector 131 is connected to a tab 111 of the battery cell 110, and the second connector 132 is connected to a pole 121. The first connector 131 has a first engaging portion 1311, the second connector 132 has a second engaging portion 1321, the first engaging portion 1311 and the second engaging portion 1321 are engaged with each other. In the battery 100 provided by embodiments of the present application, the first engaging portion 1311 is disposed on the first connector 131 and a second engaging portion 1321 matched with the first engaging portion 1311 is disposed on the second connector 132. When the first connector 131 and the second connector 132 are welded, the first engaging portion 1311 on the first connector 131 and the second engaging portion 1321 on the second connector 132 can be engaged. This can prevent the first connector 131 and the second connector 132 from sliding, thereby achieving the accurate and rapid positioning between the first connector 131 and the second connector 132, and improving the qualification rate and efficiency of producing the battery 100. The increase in the productivity of the battery 100 can make the cost of the battery 100 lower, and the increase in the qualification rate of the battery 100 can improve the safety and life of the battery 100. Because the electronic device provided in the present embodiment uses the battery 100 in the above embodiment, therefore, the cost of the electronic device can be reduced, and the safety and service life of the electronic device can be improved.

Finally, it should be noted that the foregoing embodiments are merely intended for describing the technical solutions of the present application other than limiting the present application. Although the present application is described in detail with reference to the foregoing embodiments, persons of ordinary skill in the art should understand that they may still make modifications to the technical solutions described in the foregoing embodiments or make equivalent substitutions to some or all technical features thereof, and these modifications or substitutions do not make the essence of corresponding technical solutions depart from the scope of the technical solutions of embodiments of the present application.

What is claimed is:

1. A battery, comprising a battery cell, an outer shell assembly and a first connecting assembly, the outer shell assembly comprises a pole and an outer shell, the outer shell has an accommodate chamber, and the battery cell is disposed in the accommodate chamber;
the first connecting assembly comprises a first connector and a second connector, the first connector is connected to a tab of the battery cell, the second connector is connected to the pole, the first connector has a first engaging portion, the second connector has a second engaging portion, the first engaging portion and the second engaging portion are engaged with each other.

2. The battery according to claim 1, wherein the first engaging portion is a convex portion and the second engaging portion is a concave portion, or the first engaging portion is a concave portion and the second engaging portion is a convex portion, and the convex portion is embedded in the concave portion.

3. The battery according to claim 2, wherein the first connector comprises a first connecting sheet connected to a second connector, and a fourth connecting sheet connected to a side of the tab facing away from the battery cell.

4. The battery according to claim 3, wherein the first connector further comprises a second connecting assembly connected to the first connecting sheet and the fourth connecting sheet respectively; the second connecting assembly comprises a second connecting sheet and a third connecting sheet; the second connecting sheet is located between the second connector and the battery cell; along a first direction, the third connecting sheet is located between the tab and the second connector; the first connecting sheet, the second connecting sheet, the third connecting sheet and the fourth connecting sheet are sequentially connected.

5. The battery according to claim 4, wherein the first connecting sheet has the convex portion, a side wall of the second connector has the concave portion, and the convex portion protrudes to a side of the second connector.

6. The battery according to claim 5, wherein a plurality of convex portions are provided, the plurality of convex portions are disposed at intervals on the first connecting sheet along the first direction.

7. The battery according to claim 2, wherein a cross section of the convex portion is circular-shaped or polygon-shaped.

8. The battery according to claim 2, wherein the concave portion is a through hole or a groove formed on the second connector.

9. The battery according to claim 1, wherein two first connecting assemblies are provided, and the two first connecting assemblies are connected to a positive-electrode tab and a negative-electrode tab of the battery cell respectively; the second connector in the first connecting assembly connected to the positive-electrode tab is connected to the pole, and the second connector in the first connecting assembly connected to the negative-electrode tab is connected to the outer shell.

10. The battery according to claim 4, wherein the second connector and the second connecting sheet are welded together and a welded surface between the second connector and the second connecting sheet is parallel to a bottom of the outer shell.

11. The battery according to claim 2, wherein the convex portion is a convex column, the concave portion is a concave hole, and a diameter of the convex column minus a diameter of the concave hole is greater than 0.05 mm.

12. The battery according to claim 11, wherein a height of the convex column and a depth of the concave hole are 0.5 mm-30 mm.

13. An electronic device, comprising the battery according to claim 1.
